(19) United States
(12) Patent Application Publication
(10) Pub. No.: US 2005/0069082 A1
(43) Pub. Date: Mar. 31, 2005

(54) Scanning x-ray microscope with a plurality of simultaneous x-ray probes on the sample

(76) Inventors: Bart Buijsse, Eindhoven (NL); Robert Frans Maria Hendriks, Eindhover (NL)

Correspondence Address: U S Philips Corporation;Intellectual Property Department, P O Box 3001, Briarcliff Manor, NY, 10510, US

(21) Appl. No.: 10/498,956

(22) PCT Filed: Dec. 20, 2002
(86) PCT No.: PCT/IB02/05658

(30) Foreign Application Priority Data
Dec. 21, 2001 (EP) 01205096.9

(51) Int. Cl. G21K 7/00

(52) U.S. Cl. 378/43

(57) ABSTRACT

In known single probe scanning X-ray microscopes a very thin X-ray beam is selected from X-rays generated by an X-ray source. This known technique has the drawback that very few photons only take part in irradiating the sample. Therefore, high intensity sources have to be used, such as very big and expensive synchrotron sources, or very long exposure times (100 hours) have to be accepted. According to the invention it is proposed to irradiate the sample (10) by means of radiation which is selected from the source X-ray beam (4) by means of a lattice plate (6), thus providing a plurality of N probe-forming X-ray beams selected from the main beam (4). This results in an improvement of the exposure time by a factor of N.

The invention relates to a scanning X-ray microscope which includes:

a sample location for receiving a sample to be examined by means of the microscope;

means for forming at least one X-ray probe at the area of the sample from an X-ray beam;

scanning means for scanning the X-ray probe relative to the sample;

detection means for detecting radiation emanating from the sample in response to the irradiation by means of the X-ray probe.

An X-ray microscope of this kind is known from Journal of Microscopy, Vol. 172. Pt 2, November 1993, pp. 121-129: “Scanning luminescence X-ray microscopy: imaging fluorescence dyes at suboptical resolution”. The cited article describes an X-ray microscope which utilizes optical luminescence, that is, a so-called Scanning Luminescence X-ray Microscope (SLXM). In a microscope of this kind a very thin X-ray beam is selected from the X-rays emanating from an X-ray source. This yields a small X-ray probe for scanning the sample. It is a major drawback of this technique that the X-ray probe is derived by selecting a very small fraction from a complete X-ray beam. In order to enable the sample to be irradiated with adequate intensity nevertheless, X-ray sources of very high intensity are then required, for example, a source of synchrotron radiation. Sources of this kind are not available at a laboratory scale. When a conventional X-ray tube is used, the X-rays suitable for irradiation of the sample then contain only a comparatively small number of photons per unit of time. Consequently, when use is made of such a source, the measuring times become unacceptably long, for example, of the order of magnitude of 100 hours or more.

It is an object of the invention to provide a scanning X-ray microscope of the kind set forth whereby the measuring time required to form an image is significantly reduced. To this end, the scanning X-ray microscope in accordance with the invention is characterized in that the microscope is provided with means for simultaneously forming a plurality of X-ray probes from the X-ray beam at the area of the sample, and that the detection means are constructed in the form of a position-sensitive detector.

It is thus achieved that said measuring time is reduced by a factor of the order of magnitude of the number of X-ray probes whereby the sample is simultaneously irradiated. Because radiation is now produced simultaneously in various locations in the sample, a position-sensitive detector is now required for separate detection of the radiation emanating from each point.

In an embodiment of the invention the means for simultaneously forming a plurality of X-ray probes from the X-ray beam are formed by a lattice plate of a material which blocks X-rays, said lattice plate being provided with a lattice of X-ray transmitting openings. In this embodiment the scanning of the X-ray probes can take place without changing their spacing, that is, by displacing the lattice plate over the desired distances.

In a further embodiment of the invention the lattice plate is arranged between an X-ray source producing the X-ray beam and the sample to be examined by means of the microscope, an intermediate lens being arranged between the lattice plate and the sample in order to image the lattice plate on the sample. This embodiment is particularly advantageous when very small X-ray probes are formed. Lack of sharpness due to diffraction of the X-rays on the (very small) openings could then cause a significant enlargement of the probes, giving rise to a loss of resolution. In order to prevent this, the lattice would have to be arranged at a very short distance (of the order of magnitude of one micrometer) from the sample; this is objectionable and often completely impossible in practical applications. As a result of the use of the intermediate lens, the lattice can be arranged at a much larger distance from the sample.

A preferred embodiment of the scanning X-ray microscope in accordance with the invention is constructed as a scanning luminescence X-ray microscope. For a successful microscopic technique it is important that, in addition to morphology of a sample, the functionality of a structure can also be clarified. Generally speaking, the study of functionality is dependent on fluorescent molecular markers which selectively adhere to proteins or other macromolecular structures. It is known that scanning luminescence X-ray microscopy (SLXM) enables optical fluorescence to be imaged with a high resolution by means of an X-ray microscope. The sample is scanned by means of a small X-ray spot, the optical fluorescence thus produced being captured by a microscope objective having a high numerical aperture so as to be imaged on a sensitive detector. The usability of SLXM is also dependent on the availability of markers which are stable for excitation by means of X-rays. Such markers are commercially available nowadays. The major drawback that the measuring time becomes unacceptably long when table-top X-ray sources are used in single probe X-ray microscopes is now eliminated in SLXM.

The invention will be described in detail hereinafter with reference to the Figures in which corresponding elements are denoted by corresponding reference numerals. Therein:

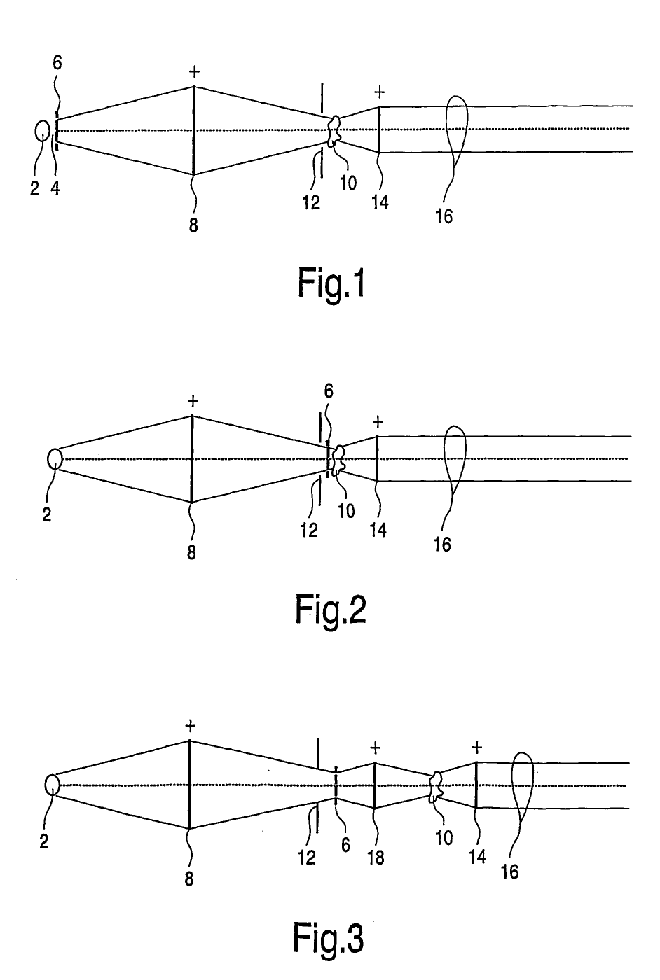

FIG. 1 shows a first, simple embodiment of the multi-probe SLXM;

FIG. 2 shows a second embodiment of the multi-probe SLXM;

FIG. 3 shows a third embodiment of the multi-probe SLXM;

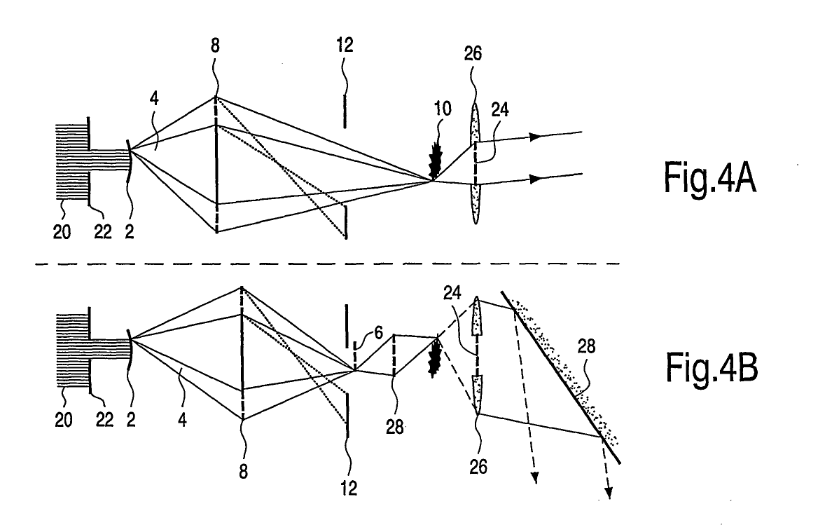

FIG. 4 shows an embodiment of a multi-probe SLXM which can be readily converted into a transmission X-ray microscope (TXM) and vice versa.

FIG. 1 is a diagrammatic representation of a first (simple) embodiment of the multi-probe luminescence scanning X-ray microscope (multi-probe SLXM). An X-ray source 2 emits an X-ray beam 4 of a wavelength which is suitable for the type of examination to be carried out by means of the microscope. For the examination of, for example, biological samples, a wavelength of between 2 and 5 nm will be chosen. An X-ray source of this kind which is particularly suitable for the present application is described in the published patent application WO 01/46962 A1. A lattice plate 6 selects a number of sub-beams (not separately shown) from the X-ray beam 4. The feasible number of sub-beams is dependent on the requirements imposed on the design of the X-ray microscope, but is typically of the order of magnitude of 400, so a lattice of 20×20 sub-beams. The lattice plate 6 is imaged on the sample 10 by means of an imaging X-ray lens 8. A beam-limiting aperture 12 is arranged in front of the sample 10 in order to block undesirable diffraction orders transmitted by the X-ray lens 8. As is known from the technical field concerning these lenses, the first-order diffraction image of the source 2 is then used to be projected onto the sample 10; all other orders (notably the zero order, that is, the straight forward and hence non-focused part of the beam) must be removed. The sub-beams generate visible light in the sample by fluorescence, said light being projected, by way of a glass lens 14, as a light beam 16 onto a position-sensitive detector (not shown), for example, a CCD array which is sensitive to visible light.

The X-ray lens 8 is a Fresnel zone plate which is known per se. Utilizing the X-ray lens 8, the lattice plate 6 forms X-ray probes of a dimension of the order of magnitude of from 50 to 100 nm at the area of the sample 10. The lattice of N×N X-ray spots is moved in parallel across the sample 10, for example, by displacement of the lattice plate 6. The spacing of the spots is chosen to be such that the fluorescence signals originating from two neighboring spots can be discriminated by the optical detection system formed by the glass lens 14 and the CCD array. A fluorescence image having a resolution equal to the size of the X-ray spots can thus be detected, while in comparison with “single probe” scans the measuring time is reduced by a factor of N2. The lattice plate 6 should have a thickness t which is large enough to provide complete absorption of the X-rays, whereas the dimensions of the openings therein determine the dimension of the X-ray probes on the sample. If an opening in the lattice plate has a diameter d and the spacing is 1, the lattice plate will have a transmission equal to the (d/1)2. In practice the ratio d/1 will be determined by the ratio of the X-ray resolution to the optical resolution, meaning that d is then from 5 to 10 times smaller than 1. This ratio results from the fact that the wavelength of visible light is approximately 0.5 μm whereas the dimension of the X-ray probe is approximately 50 nm, so that they differ by a factor of 10.

In FIG. 1 the N×N lattice plate 6 is arranged directly behind the source 2 and the plane in which the lattice plate is situated is imaged on the sample. In given circumstances this arrangement of the various components may be objectionable. Even though it is desirable that the lattice plate 6 is situated as near as possible to the source 2 (with a view to realizing a large space angle in order to collect an as large as possible amount of X-rays), it may notably be objectionable that the lattice plate 6 is contaminated when use is made of an X-ray source producing contamination, or a situation may occur where no space is available for the lattice plate at that area. These drawbacks are mitigated by means of an arrangement as shown in FIG. 2.

The embodiment shown in FIG. 2 mitigates the described drawbacks by arranging the lattice plate 6 behind the beam-limiting aperture 12. The lattice plate is now no longer close to the source 2 and hence can no longer be contaminated thereby. The source is now imaged on the sample 10 by the X-ray lens 8, the splitting into sub-beams forming X-ray probes by the lattice plate now taking place directly in front of the sample. Even though the above drawbacks are mitigated in this arrangement, it may still occur (notably in the case of high resolution) that diffraction of the X-rays on the openings in the lattice plate has a disturbing effect on the desired high resolution. It would be feasible to eliminate this drawback by arranging the lattice plate 6 at a very short distance from the sample, but it may occur that no space is available for this purpose and/or that the distance between the lattice plate and the sample would have to be so small that it is not feasible in practical circumstances. In situations in which the latter aspect is objectionable use can be made of the arrangement shown in FIG. 3.

The embodiment shown in FIG. 3 mitigates the described drawback of reduced resolution due to diffraction by inserting an imaging X-ray lens 18 between the lattice plate 6 and the sample 10 in the arrangement shown in FIG. 2. The latter X-ray lens images the lattice plate 6 on the sample 10. As is known, the effect of the diffraction on the openings in the plate is negligibly small when the lattice plate is imaged on the sample.

FIG. 4 shows an embodiment of a multi-probe SLXM which can be readily converted into a transmission X-ray microscope (TXM) and vice versa. FIG. 4a shows a TXM and FIG. 4b shows an SLXM. In the TXM of FIG. 4a X-rays are generated by means of an X-ray source as disclosed in the cited WO document. An electron beam collimated therein by an aperture 22 strikes a jet of water in which the X-rays are generated, thus forming an X-ray source 2. Subsequently, the X-ray beam 4 thus produced is imaged on the sample 10 in slightly enlarged form by an X-ray lens 8 which acts as a condenser. A typical dimension of the X-ray source 2 is 10 μm. In front of the sample 10 there is arranged a so-called “order sorting aperture” 10 which transmits the desired focusing order. The aperture 10 also acts as a monochromator for the incident focus, so that the subsequent lenses do not introduce a loss of resolution due to chromatic aberration. Subsequently, an image is formed on an X-ray sensitive CCD camera by means of an X-ray lens 24 in the form of a microzone plate acting as the objective lens. The objective lens can be constructed as a combination lens 26, meaning that an X-ray zone plate of approximately 0.1 mm is taken up in a glass lens having a typical dimension of a few millimeters. A typical value of the magnification is of the order of magnitude of 500 or 1000. In the case of a customary numerical aperture of the system of 0.05 and an efficiency of the condenser lens of 5%, approximately 2.10´5 fot./μm/2 will be incident on the sample 10. The formation of an image will then take approximately 8 minutes.

In order to form a multi-probe SLXM image, the arrangement is adapted as shown in FIG. 4b. The source 2, the sample 10 and the objective lens retain their positions, but in FIG. 4b a 1:1 image of the source 2 is formed on the lattice plate 6. Subsequently, this lattice plate is imaged in slightly enlarged form on the sample 10 by means of an X-ray zone plate 28.

The objective lens used to focus the light produced by fluorescence can be integrated with the objective zone plate 24 so as to form the combination lens 26. The fluorescence signal can be imaged on a light-sensitive CCD camera (not shown) by means of an additional mirror 28.

The CCD camera will have to form an image for each position of the lattice. The high-resolution image is ultimately obtained by combining the images for the various lattice positions. However, this requires only very simple image processing steps which are known per se.

1. A scanning X-ray microscope which includes:
a sample location for receiving a sample (10) to be examined by means of the microscope;
means for forming at least one X-ray probe at the area of the sample from an X-ray beam (4);
scanning means for scanning the X-ray probe relative to the sample;
detection means for detecting radiation emanating from the sample in response to the irradiation by means of the X-ray probe; characterized in that the microscope is provided with means (6) for simultaneously forming a plurality of X-ray probes from the X-ray beam (4) at the area of the sample (10), and that the detection means are constructed in the form of a position-sensitive detector.

2. A scanning X-ray microscope as claimed in claim 1, in which the means for simultaneously forming a plurality of X-ray probes from the X-ray beam are formed by a lattice plate (6) of a material which blocks X-rays, said lattice plate being provided with a grid of X-ray transmitting openings.

3. A scanning X-ray microscope as claimed in claim 2, in which the lattice plate (6) is arranged between an X-ray source (2) producing the X-ray beam and the sample (10) to be examined by means of the microscope, an intermediate lens (16) being arranged between the lattice plate and the sample in order to image the lattice plate on the sample sample.

4. A scanning X-ray microscope as claimed in claim 1 which is constructed as a scanning luminescence X-ray microscope.
